(19) United States
(12) Patent Application Publication
(10) Pub. No.: US 2026/0129033 A1
(43) Pub. Date: May 7, 2026

(54) PRACTICAL ANONYMITY WITH LONG-TERM RESISTANCE TO TRAFFIC ANALYSIS

(71) Applicant: The regents of the Univerity of California, Oakland, CA (US)

(72) Inventors: Kyle Bradley Frederickson, Chicago, IL (US); Ioannis Demertzis, San Jose, CA (US); Darrell Don Earl Long, Soquel, CA (US)

(21) Appl. No.: 19/381,965

(22) Filed: Nov. 6, 2025

Related U.S. Application Data
(60) Provisional application No. 63/716,979, filed on Nov. 6, 2024.

(51) Int. Cl. H04L 9/40

(52) U.S. Cl. CPC H04L 63/0428

(57) ABSTRACT

Systems and methods for secure and anonymous communication using a hardware enclave is disclosed. The method involves receiving push requests to store messages and fetch requests to retrieve messages within the enclave.

Messages are stored in an oblivious data structure and retrieved in predetermined quantities based on recipient-specific parameters. Retrieved messages are padded to fixed sizes before sending to recipients. The system achieves traffic analysis resistance by revealing only limited information about communication patterns-specifically, the sender and timing of sent messages, and the total volume and timing of messages received by each recipient, without disclosing correlations between sent and received messages. The method employs flexible padding functions and asynchronous retrieval to further enhance security.

### CLAIM OF PRIORITY

This application claims the benefit of U.S. Provisional Patent Application No. 63/716,979 , filed Nov. 6, 2024, entitled “PRACTICAL ANONYMITY WITH LONG-TERM RESISTANCE TO TRAFFIC ANALYSIS,” which is incorporated herein by reference in its entirety.

### TECHNICAL FIELD

Embodiments of the present disclosure relate generally to secure communication systems, and more specifically to anonymous messaging, metadata protection, and traffic analysis resistance.

### BACKGROUND

Secure communication systems have become increasingly important in the digital age, with a growing need for protecting not only message contents but also metadata associated with communications. Existing messaging services often employ end-to-end encryption to safeguard message contents, but this leaves metadata exposed to potential adversaries. Metadata, which includes information about who is communicating with whom, when, and how much, can be a rich source of information that may render message contents superfluous.

Anonymous communication has been an active field of research, with various systems proposed to address metadata privacy. However, widely deployed systems like Tor operate under weak adversary models and offer weak guarantees even within those models. For example, Tor, while popular, is known to be vulnerable to traffic analysis attacks.

Some systems have attempted to provide stronger security guarantees against global adversaries capable of observing all network links. These systems may rely on techniques such as mixnets, secret-sharing based schemes, or differential privacy. However, they often suffer from significant security, are vulnerable to traffic analysis, and usability problems preclude their adoption in real-world scenarios.

Many of these systems impose strict bandwidth restrictions or make unrealistic assumptions about user behavior to achieve security, leading to poor performance or impractical deployment requirements. For instance, some systems require users to send exactly one message per round, which is unenforceable and can result in prohibitively high latencies.

Accordingly, there is a recognized need for metadata-private communication systems that can provide long-term security against traffic analysis while maintaining practical performance and usability. Such systems should ideally operate without imposing global bandwidth restrictions, support multiple concurrent conversations without message loss, and be readily deployable by single organizations.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram showing a system for exchanging data (e.g., messages and associated content) over a network in accordance with some embodiments, wherein the messaging system includes an anonymous messaging system.

FIG. 2 is flowchart illustrating a method for anonymous messaging, according to certain examples.

FIG. 3 is flowchart illustrating a method of padding retrieved messages to a fixed size, according to certain examples.

FIG. 4 is flowchart illustrating a method of determining a fixed size, according to certain examples.

FIG. 5 is flowchart illustrating a method of determining a fetch volume parameter, according to certain examples.

FIG. 6 is a block diagram illustrating a representative software architecture, which may be used in conjunction with various hardware architectures herein described and used to implement various embodiments.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

As discussed above, current end-to-end encrypted messaging systems protect message contents but fail to adequately secure metadata, leaving users vulnerable to traffic analysis attacks. Existing metadata-private communication systems either lack scalability or are susceptible to long-term traffic analysis. Systems that attempt to mitigate traffic analysis often rely on unrealistic user assumptions or impose system-wide bandwidth restrictions, significantly impacting usability and performance.

According to certain examples, the disclosed invention addresses the problem of metadata privacy in communication systems by utilizing a hardware enclave to provide secure and anonymous messaging. The system receives push requests from senders to store messages for recipients within an oblivious data structure in the hardware enclave. When recipients send fetch requests, the system retrieves a predetermined number of messages, pads them to a fixed size, and sends them to the recipient. This approach achieves traffic analysis resistance by revealing only limited information about communication patterns such that the output volume is independent of the input volume (per user)—thereby avoiding any disclosure of correlations between sent and received messages.

In some examples, the system employs several features to enhance security and performance. It uses an oblivious data structure to conceal access patterns, making it impossible for adversaries to determine which data is being accessed or modified. Flexible padding functions are implemented to control the volume of responses, ensuring that the output volume is independent of the input volume. The system may support asynchronous message retrieval, allowing variable fetch rates for users so long as changes in fetch rates do not depend on actual received traffic.

In some examples, the system utilizes a deferred retrieval approach, where a fetch volume parameter is determined for each recipient, and excess messages are deferred to subsequent fetch requests. In some examples, the system implements exponential padding, where the fixed size for message padding is calculated based on an exponential value derived from the total number of messages. Accordingly, the system also supports recipient-specific retrieval, where the quantity of messages retrieved is tailored to each user's expected traffic patterns.

In some examples, the system may implement a distributed architecture, distributing messages across multiple submaps. It also includes scalability optimizations for different scenarios, such as low-latency for a large number of users or high-throughput when the number of users is close to the size of the message database. Users can verify the proper initialization of the hardware enclave, providing an additional layer of security. The system also includes a queue maintainer to manage per-user metadata for message queueing.

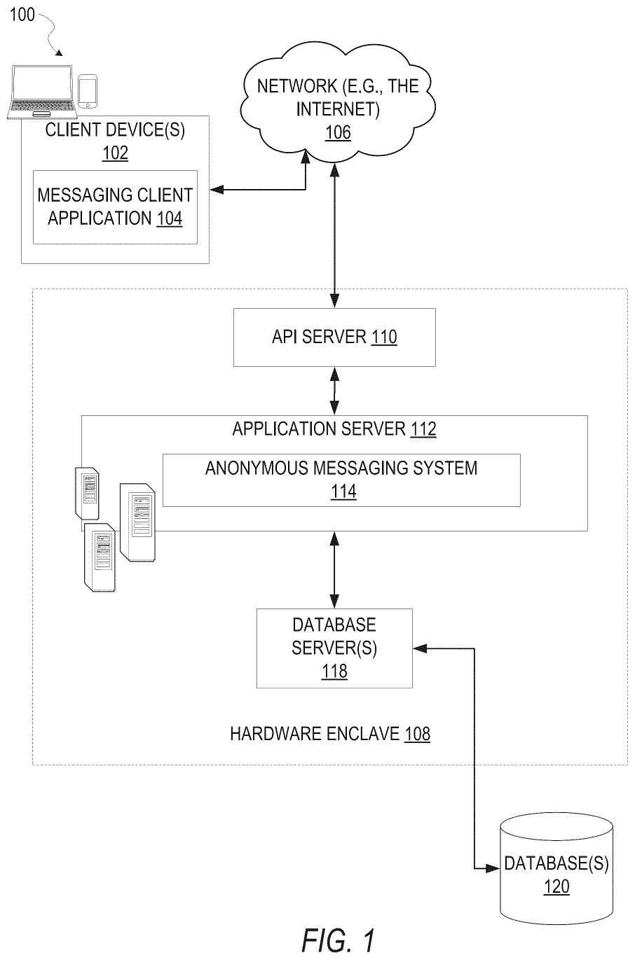

FIG. 1 is a block diagram showing an example messaging system 100 for exchanging data (e.g., messages and associated content) over a network. The messaging system 100 includes multiple client devices 102, each of which hosts a number of applications including a messaging client application 104. Each messaging client application 104 is communicatively coupled to other instances of the messaging client application 104 and a messaging server system 108 via a network 106 (e.g., the Internet).

Each messaging client application 104 is able to communicate and exchange data with another messaging client application 104 via the anonymous messaging system 114, with the messaging server system 108 via the network 106. Accordingly, in some examples, all client-to-client communication is mediated by the anonymous messaging system 114. The data exchanged between messaging client applications 104, and between a messaging client application 104 and the messaging server system 108, includes functions (e.g., commands to invoke functions) as well as payload data (e.g., text, audio, video or other multimedia data).

The hardware enclave 108 provides server-side functionality via the network 106 to a particular messaging client application 104. While certain functions of the messaging system 100 are described herein as being performed by either a messaging client application 104 or by the messaging server system 108, it will be appreciated that the location of certain functionality either within the messaging client application 104 or the messaging server system 108 is a design choice. For example, it may be technically preferable to initially deploy certain technology and functionality within the hardware enclave 108, but to later migrate this technology and functionality to the messaging client application 104 where a client device 102 has a sufficient processing capacity. In some examples, the hardware enclave 108 is central to the security guarantees of the anonymous messaging system 114, and all functionality related to processing messages and managing sensitive data may remain within the hardware enclave 108 to maintain the system's privacy and security properties.

The hardware enclave 108 supports core security functions essential for the anonymous messaging system. These include loading data in and out of protected memory, performing protected computations on that data, providing attestation to verify the enclave's integrity, and sealing data for secure storage. In some embodiments, this data includes, message content, client device information, geolocation information, media annotation and overlays, message content persistence conditions, social network information, and live event information, as examples. In other embodiments, other data is used. Data exchanges within the messaging system 100 are invoked and controlled through functions available via GUIs of the messaging client application 104.

The application server 112, which hosts the hardware enclave 108, is coupled to an Application Program Interface (API) server 110 that provides a programmatic interface. The application server 112 is also communicatively coupled to a database server 118, which facilitates access to a database 120. The hardware enclave resides within the application server 112, providing secure computation and data protection capabilities essential for the anonymous messaging system.

Dealing specifically with the Application Program Interface (API) server 110, this server receives and transmits message data (e.g., commands and message payloads) between the client device 102 and the application server 112. Specifically, the Application Program Interface (API) server 110 provides a set of interfaces (e.g., routines and protocols) that can be called or queried by the messaging client application 104 in order to invoke functionality of the application server 112. The Application Program Interface (API) server 110 exposes various functions supported by the application server 112, including account registration, login functionality, the sending of messages, via the application server 112, from a particular messaging client application 104 to another messaging client application 104, and for possible access by another messaging client application 104, the setting of a collection of media data (e.g., story), the retrieval of a list of friends of a user of a client device 102, the retrieval of such collections, the retrieval of messages and content, the adding and deletion of friends to a social graph, the location of friends within a social graph, opening and application event (e.g., relating to the messaging client application 104).

The application server 112 may host an anonymous messaging system 114. The anonymous messaging system 114 performs several functions to ensure secure and private message handling. It manages the storage of encrypted messages in a way that conceals access patterns, making it difficult for adversaries to determine which data is being accessed or modified.

The system handles oblivious access to the stored messages, ensuring that all memory accesses appear random to outside observers. When fetch requests are received, it retrieves a predetermined number of messages for the recipient.

The anonymous messaging system 114 also implements padding functions to control response volumes and maintain consistent traffic patterns, including padding retrieved messages to a fixed size before sending them to the recipient.

It controls information disclosure by implementing leakage functions that reveal only limited information about communication patterns, specifically the sender and timing of sent messages (St) and the total volume of messages received by each recipient (R). The system manages per-user metadata for message queueing and efficient message retrieval.

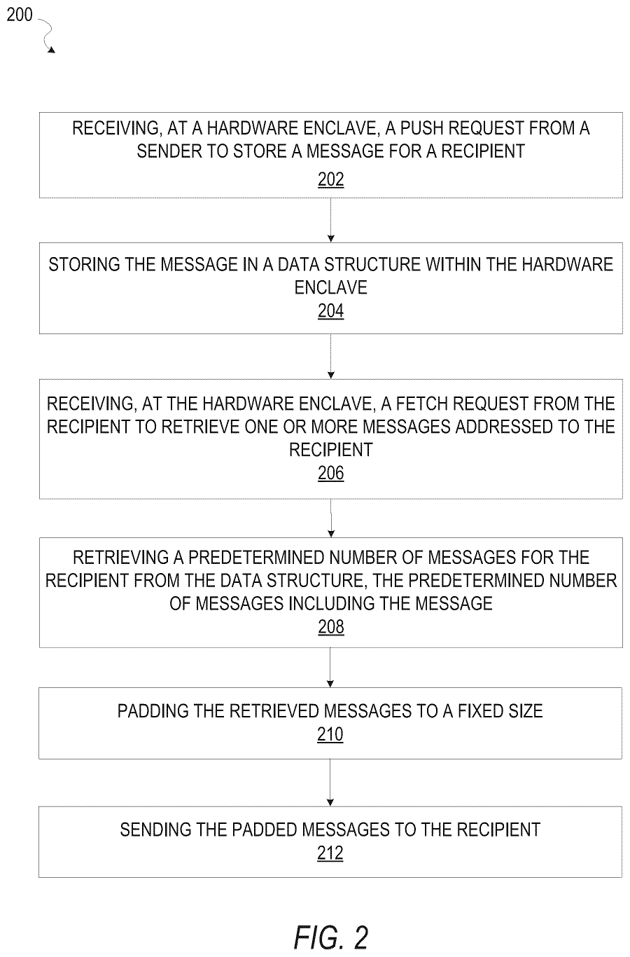

FIG. 2 is a flowchart illustrating a method 200 for anonymous messaging, according to certain examples.

The method begins at operation 202 with receiving, at a hardware enclave, a push request from a sender to store a message for a recipient. This operation involves the sender submitting an encrypted message to the system, which is then securely processed within the hardware enclave.

Next, at operation 204, the method proceeds to storing the message in a data structure within the hardware enclave. This data structure is designed to be oblivious, concealing access patterns and making it difficult for adversaries to determine which data is being accessed or modified.

At operation 206, the system receives, at the hardware enclave, a fetch request from the recipient to retrieve one or more messages addressed to the recipient. This operation occurs when a recipient wants to check for new messages.

Following the fetch request, at operation 208, the system retrieves a predetermined number of messages for the recipient from the data structure, the predetermined number of messages including the message. This operation involves the system accessing the oblivious data structure to fetch the appropriate messages for the recipient.

At operation 210, the system pads the retrieved messages to a fixed size, and at operation 212, the system sends the padded messages to the recipient.

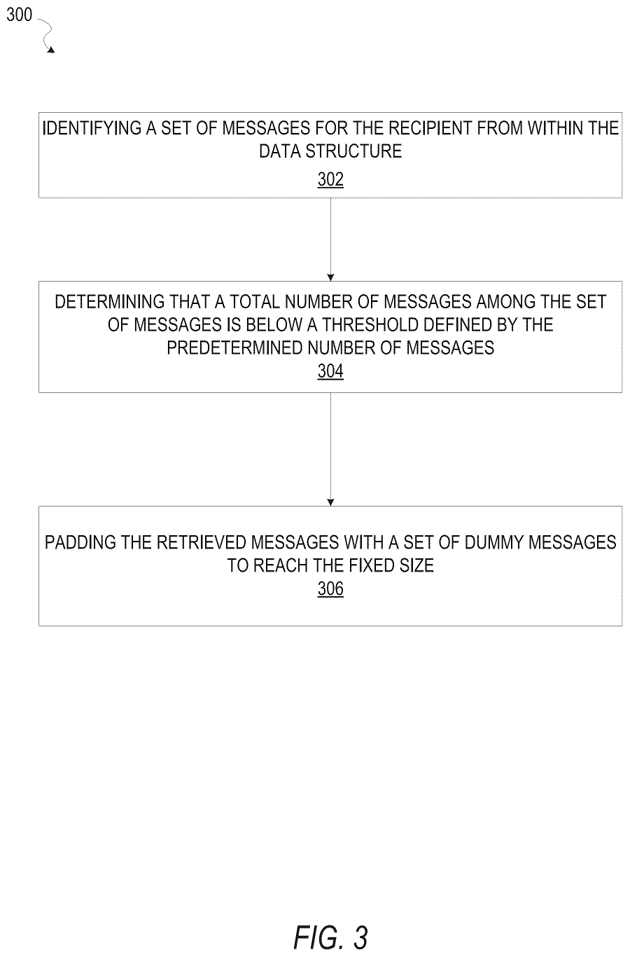

FIG. 3 is flowchart illustrating a method 300 of padding retrieved messages to a fixed size, according to certain examples. The method 300 is performed by the anonymous messaging system 114 within the hardware enclave 108.

At operation 302, the system identifies a set of messages for the recipient from within the data structure. This operation involves the anonymous messaging system 114 accessing the oblivious data structure to locate messages addressed to the specific recipient, responsive to a request from the recipient.

At operation 304, the system determines that a total number of messages among the set of messages is below a threshold defined by the predetermined number of messages. The system compares the number of actual messages retrieved for the recipient against a predefined threshold, which represents the desired fixed size for the message set.

At operation 306, the system pads the retrieved messages with a set of dummy messages to reach the fixed size. If the actual number of messages is below the threshold, the system adds dummy messages to ensure that the total number of messages reaches the fixed size.

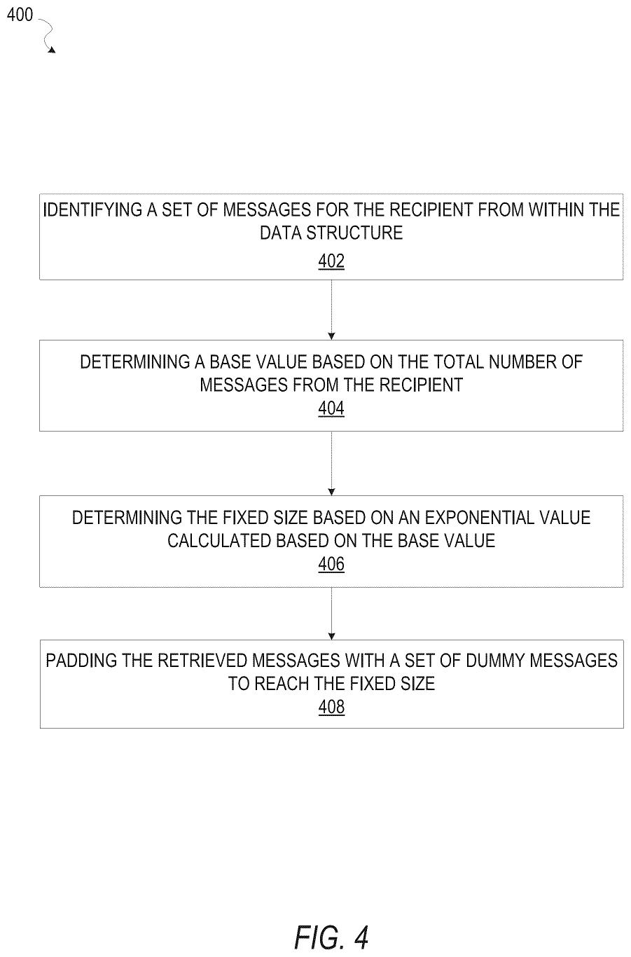

FIG. 4 is flowchart illustrating a method 400 of determining a fixed size, according to certain examples.

At operation 402, the system identifies a set of messages for the recipient from within the data structure. For example, the anonymous messaging system 114 may access an oblivious data structure to locate messages addressed to the specific recipient.

At operation 404, the system determines a base value based on the total number of messages from the recipient. The system calculates a base value that is derived from the total number of messages associated with the recipient.

At operation 406, the system determines the fixed size based on an exponential value calculated based on the base value. Using the base value determined in the previous step, the system calculates an exponential value to determine the fixed size for padding.

At operation 408, the system pads the retrieved messages with a set of dummy messages to reach the fixed size. The system adds dummy messages to ensure that the total number of messages reaches the calculated fixed size.

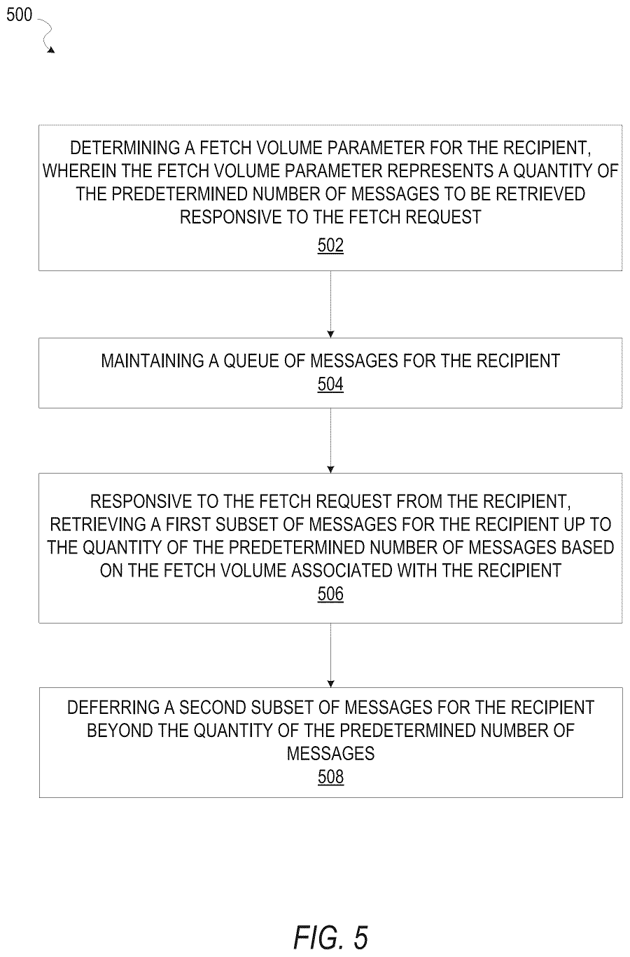

FIG. 5 is flowchart illustrating a method 500 of determining a fetch volume parameter, according to certain examples.

At operation 502, the system determines a fetch volume parameter for the recipient, wherein the fetch volume parameter represents a quantity of the predetermined number of messages to be retrieved responsive to the fetch request. In some examples, a user may determine and set their own fetch volume parameter. This parameter should be set independently of the user's actual received traffic volume to maintain privacy. Users establish this parameter based on their estimated maximum traffic rate and their tolerance for latency and overhead. In certain examples, the system may not determine or automatically adjust this parameter, as doing so could potentially leak information about communication patterns.

According to certain examples, to set an appropriate fetch volume parameter, the following factors may be considered: estimated maximum daily message volume; desired balance between latency (time to receive messages) and overhead (dummy traffic); typical usage patterns and connectivity.

The fetch volume parameter may be adjusted over time, but adjustments should be made infrequently to minimize potential information leakage. The goal is to establish a parameter that accommodates communication needs while maintaining consistent traffic patterns to resist traffic analysis.

In some examples, the fetch volume parameter may be determined by the system based on observed usage patterns and predefined security thresholds. This could involve machine learning algorithms that analyze historical data to predict optimal fetch volumes while preserving anonymity. At operation 504, the system maintains a queue of messages for the recipient. The system manages a queue of messages specific to each recipient within the oblivious data structure.

At operation 506, responsive to the fetch request from the recipient, the system retrieves a first subset of messages for the recipient up to the quantity of the predetermined number of messages based on the fetch volume associated with the recipient. When a fetch request is received, the system retrieves messages up to the limit defined by the fetch volume parameter.

At operation 508, the system defers a second subset of messages for the recipient beyond the quantity of the predetermined number of messages. If there are more messages in the queue than the fetch volume parameter allows, these additional messages are deferred for future retrieval.

### Software Architecture

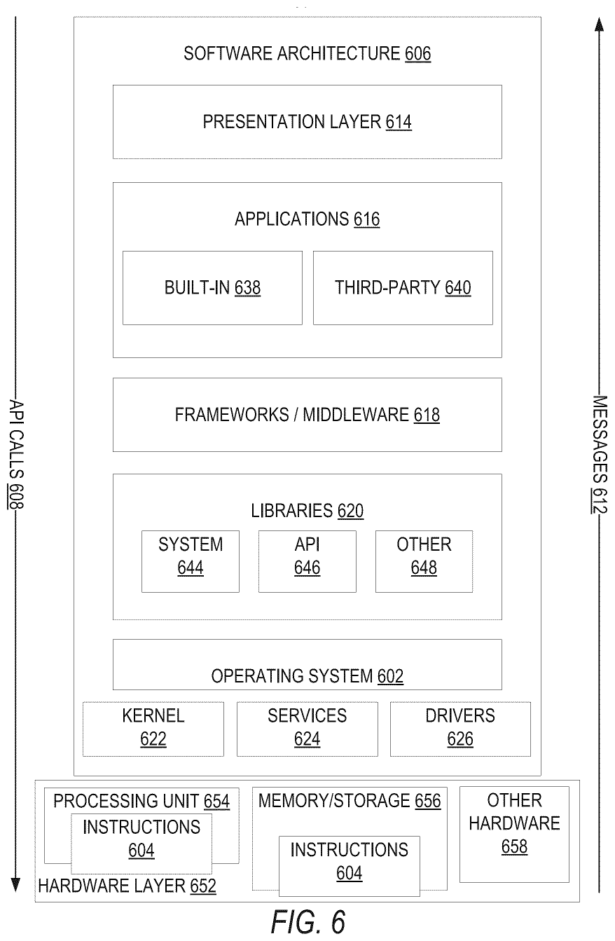

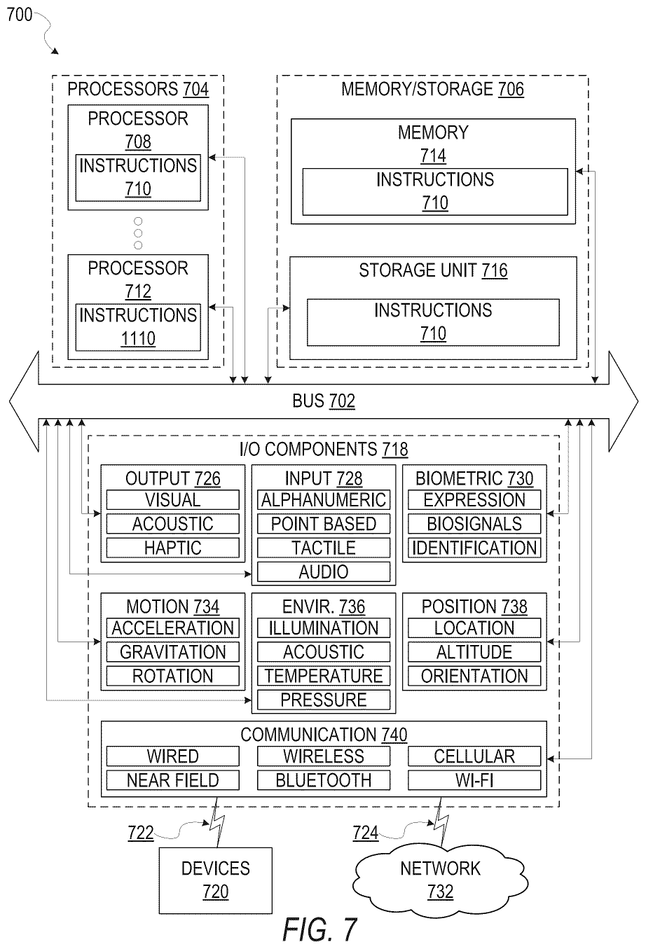

FIG. 6 is a block diagram illustrating an example software architecture 606, which may be used in conjunction with various hardware architectures herein described. FIG. 6 is a non-limiting example of a software architecture and it will be appreciated that many other architectures may be implemented to facilitate the functionality described herein. The software architecture 606 may execute on hardware such as the machine 700 of FIG. 7 that includes, among other things, processors 704, memory 714, and I/O components 718. A representative hardware layer 652 is illustrated and can represent, for example, the machine 600 of FIG. 6. The representative hardware layer 1052 includes a processing unit 654 having associated executable instructions 604. Executable instructions 604 represent the executable instructions of the software architecture 606, including implementation of the methods, components and so forth described herein. The hardware layer 652 also includes memory and/or storage modules memory/storage 656, which also have executable instructions 604. The hardware layer 652 may also comprise other hardware 658.

In the example architecture of FIG. 6, the software architecture 606 may be conceptualized as a stack of layers where each layer provides particular functionality. For example, the software architecture 606 may include layers such as an operating system 602, libraries 620, applications 616 and a presentation layer 614. Operationally, the applications 616 and/or other components within the layers may invoke application programming interface (API) API calls 608 through the software stack and receive a response as in response to the API calls 608. The layers illustrated are representative in nature and not all software architectures have all layers. For example, some mobile or special purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624 and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 620 provide a common infrastructure that is used by the applications 616 and/or other components and/or layers. The libraries 620 provide functionality that allows other software components to perform tasks in an easier fashion than to interface directly with the underlying operating system 602 functionality (e.g., kernel 622, services 624 and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components/modules.

The frameworks/middleware 618 (also sometimes referred to as middleware) provide a higher-level common infrastructure that may be used by the applications 616 and/or other software components/modules. For example, the frameworks/middleware 618 may provide various graphic user interface (GUI) functions, high-level resource management, high-level location services, and so forth. The frameworks/middleware 618 may provide a broad spectrum of other APIs that may be utilized by the applications 616 and/or other software components/modules, some of which may be specific to a particular operating system 602 or platform.

The applications 616 include built-in applications 638 and/or third-party applications 640. Examples of representative built-in applications 638 may include, but are not limited to, a contacts application, a browser application, a book reader application, a location application, a media application, a messaging application, and/or a game application. Third-party applications 640 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 640 may invoke the API calls 608 provided by the mobile operating system (such as operating system 602) to facilitate functionality described herein.

The applications 616 may use built in operating system functions (e.g., kernel 622, services 624 and/or drivers 626), libraries 620, and frameworks/middleware 618 to create user interfaces to interact with users of the system. Alternatively, or additionally, in some systems interactions with a user may occur through a presentation layer, such as presentation layer 614. In these systems, the application/component “logic” can be separated from the aspects of the application/component that interact with a user.

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 710, sequentially or otherwise, that specify actions to be taken by machine 700. Further, while only a single machine 700 is illustrated, the term “machine” shall also be taken to include a collection of machines that individually or jointly execute the instructions 710 to perform any one or more of the methodologies discussed herein.

The machine 700 may include processors 704, memory memory/storage 706, and I/O components 718, which may be configured to communicate with each other such as via a bus 702. The memory/storage 706 may include a memory 714, such as a main memory, or other memory storage, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of processors 704 are examples of machine-readable media.

The I/O components 718 may include a wide variety of components to receive input, provide output, produce output, transmit information, exchange information, capture measurements, and so on. The specific I/O components 718 that are included in a particular machine 700 will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion and the grouping is in no way limiting. In various example embodiments, the I/O components 718 may include output components 726 and input components 728. The output components 726 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 718 may include biometric components 730, motion components 734, environmental environment components 736, or position components 738 among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 may include acceleration sensor components (e.g., accelerometer), gravitation sensor components, rotation sensor components (e.g., gyroscope), and so forth. The environment components 736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 738 may include location sensor components (e.g., a Global Position system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 732 or devices 720 via coupling 722 and coupling 724 respectively. For example, the communication components 740 may include a network interface component or other suitable device to interface with the network 732. In further examples, communication components 740 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 720 may be another machine or any of a wide variety of peripheral devices (e.g., a peripheral device coupled via a Universal Serial Bus (USB)).

Moreover, the communication components 740 may detect identifiers or include components operable to detect identifiers. For example, the communication components 740 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as, location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

What is claimed is:

1. A method comprising:
receiving, at a hardware enclave, a push request from a sender to store a message for a recipient;
storing the message in a data structure within the hardware enclave;
receiving, at the hardware enclave, a fetch request from the recipient to retrieve one or more messages;
retrieving a predetermined number of messages for the recipient from the data structure, the predetermined number of messages including the message;
padding the retrieved messages to a fixed size; and
sending the padded messages to the recipient.

2. The method of claim 1, wherein the data structure includes an oblivious data structure.

3. The method of claim 1, wherein the padding the retrieved message to the fixed size includes:
identifying a set of messages for the recipient from within the data structure;
determining that a total number of messages among the set of messages is below a threshold defined by the predetermined number of messages; and
padding the retrieved messages with a set of dummy messages to reach the fixed sizes based on the total number of messages.

4. The method of claim 1, wherein the padding the retrieved message to the fixed size includes:
identifying a set of messages for the recipient from within the data structure;
determining a base value based on the total number of messages for the recipient;
determining the fixed size based on an exponential value calculated based on the base value; and
padding the retrieved messages with a set of dummy messages to reach the fixed size.

5. The method of claim 1, wherein a quantity of the predetermined number of messages is based on the recipient.

6. The method of claim 1, further comprising:
determining a fetch volume parameter for the recipient, wherein the fetch volume parameter represents a quantity of the predetermined number of messages to be retrieved responsive to the fetch request;
maintaining a queue of messages for the recipient; and responsive to the fetch request from the recipient:
retrieving a first subset of messages for the recipient up to the quantity of the predetermined number of messages based on the fetch volume associated with the recipient; and
deferring a second subset of messages for the recipient beyond the quantity of the predetermined number of messages.

7. The method of claim 1, wherein the data structure is organized across multiple submaps.

8. A system comprising:
a hardware enclave configured to perform operations comprising:
receiving a push request from a sender to store a message for a recipient;
storing the message in a data structure within the hardware enclave;
receiving a fetch request from the recipient to retrieve one or more messages;
retrieving a predetermined number of messages for the recipient from the data structure, the predetermined number of messages including the message;
padding the retrieved messages to a fixed size; and
sending the padded messages to the recipient.

9. The system of claim 8, wherein the data structure includes an oblivious data structure.

10. The system of claim 8, wherein the padding the retrieved messages to the fixed size includes:
identifying a set of messages for the recipient from within the data structure;
determining that a total number of messages among the set of messages is below a threshold defined by the predetermined number of messages; and
padding the retrieved messages with a set of dummy messages to reach the fixed size based on the total number of messages.

11. The system of claim 8, wherein the padding the retrieved messages to the fixed size includes:
identifying a set of messages for the recipient from within the data structure;
determining a base value based on the total number of messages for the recipient;
determining the fixed size based on an exponential value calculated based on the base value; and
padding the retrieved messages with a set of dummy messages to reach the fixed size.

12. The system of claim 8, wherein a quantity of the predetermined number of messages is based on the recipient.

13. The system of claim 8, wherein the operations further comprise:
determining a fetch volume parameter for the recipient, wherein the fetch volume parameter represents a quantity of the predetermined number of messages to be retrieved responsive to the fetch request;
maintaining a queue of messages for the recipient; and
responsive to the fetch request from the recipient:
retrieving a first subset of messages for the recipient up to the quantity of the predetermined number of messages based on the fetch volume associated with the recipient; and
deferring a second subset of messages for the recipient beyond the quantity of the predetermined number of messages.

14. The system of claim 8, wherein the data structure is organized across multiple submaps.

15. The system of claim 8, further comprising:
an application server hosting the hardware enclave;
an API server communicatively coupled to the hardware enclave and configured to receive the push requests and fetch requests; and
a database server communicatively coupled to the application server.

16. The system of claim 15, further comprising client devices hosting messaging client applications configured to submit the push requests and fetch requests to the hardware enclave via the API server.

17. A non-transitory computer-readable medium storing instructions that, when executed by a processor within a hardware enclave, cause the processor to perform operation comprising:
receiving a push request from a sender to store a message for a recipient;
storing the message in a data structure within the hardware enclave;
receiving a fetch request from the recipient to retrieve one or more messages;
retrieving a predetermined number of messages for the recipient from the data structure, the predetermined number of messages including the message;
padding the retrieved messages to a fixed size; and
sending the padded messages to the recipient.

18. The non-transitory computer-readable medium of claim 17, wherein the data structure includes an oblivious data structure.

19. The non-transitory computer-readable medium of claim 17, wherein the padding the retrieved messages to the fixed size includes:
identifying a set of messages for the recipient from within the data structure;
determining that a total number of messages among the set of messages is below a threshold defined by the predetermined number of messages; and
padding the retrieved messages with a set of dummy messages to reach the fixed size based on the total number of messages.

20. The non-transitory computer-readable medium of claim 17, wherein the data structure is organized across multiple submaps.
